(19) United States
(12) Patent Application Publication
(10) Pub. No.: US 2014/0085407 A1
(43) Pub. Date: Mar. 27, 2014

(54) Portable Imaging System with a Mobile Device as Input and Output Mechanism

(71) Applicants: Romain CLEMENT, Mountain View, CA (US); David Bort, Palo Alto, CA (US); Brian Patton, Tel Aviv (IL)

(72) Inventors: Romain CLEMENT, Mountain View, CA (US); David Bort, Palo Alto, CA (US); Brian Patton, Tel Aviv (IL)

(73) Assignee: Google Inc., Mountain View, CA (US)

(21) Appl. No.: 13/174,588

(22) Filed: Jun. 30, 2011

(51) Int. Cl. H04N 7/00; H04N 5/225

(52) U.S. Cl. 348/36; 348/207.1; 348/207.11; 348/E07.077; 348/E05.048

(57) ABSTRACT

An apparatus, method, and system are provided for portable imaging system input using a mobile device. The apparatus includes an imaging device, a mobile communication device, and a communication network interface. The imaging device is arranged to capture an image. The mobile communication device is arranged to provide an interface to the imaging device and to accept input from a user. The mobile communication device also includes a presentation device to convey information to the user and can send information to and receive information from the imaging device. The communication network interface is arranged to access a communication network and provide a link between the communication network and the imaging device.

### BACKGROUND

1. Field

Embodiments generally relate to control of a portable imaging system.

2. Background

Portable imaging systems, such as those used to capture panoramic images, require the operator of an imaging system to capture an image, or set of images, and then store them on some type of storage device for processing at a later time, typically after the operator has left the location where the images were captured. As a result, it is difficult to correct any errors in the images that would require the operator to return to the original location. In addition, errors can occur when associating images with the proper location as such associating, cataloging, and processing are performed after the operator has left the imaging location. Furthermore, any captured images cannot be immediately shared or processed and thus create inefficiencies.

### BRIEF SUMMARY

Control of an imaging system with the ability to communicate real time captured images and related information to a remote location using an energy efficient and reliable system is provided.

In an embodiment, there is provided an imaging system that includes an imaging device, a mobile communication device, and a communication network interface. The imaging device is arranged to capture an image. The mobile communication device is arranged to provide an interface to the imaging device and to accept input from a user. The mobile communication device also includes a presentation device to convey information to the user and can send information to and receive information from the imaging device. The communication network interface is arranged to access a communication network and provide a link between the communication network and the imaging device.

In a further embodiment, there is provided a method that includes receiving a user input directed to a mobile communication device, sending, from the mobile communication device, information to an imaging system based on the user input, receiving, by the mobile communication device, additional information from the imaging system, and presenting information to the user based on the information sent to the imaging device and received by the mobile communication device. The method further includes accessing a communication network using the mobile communication device and linking the imaging system to the communication network using the mobile communication device.

Further embodiments and features, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the information contained herein.

### BRIEF DESCRIPTION OF THE DRAWINGS/FIGURES

Embodiments of the invention will now be described, by way of example only, with reference to the accompanying drawings in which corresponding reference symbols indicate corresponding parts. Further, the accompanying drawings, which are incorporated herein and form part of the specification, illustrate the embodiments of present invention and, together with the description, further serve to explain the principles of the invention and to enable a person skilled in the relevant art(s) to make and use the invention.

FIG. 1 illustrates a portable imaging system with a mobile communication device as an input and output mechanism to an imaging device, according to an embodiment.

FIG. 2 illustrates a detailed functional design of a mobile communication device configured to communicate with an imaging device and a communication network, according to an embodiment.

FIG. 3 illustrates a method of using a mobile communication device to send and receive information to an imaging device, according to an embodiment.

FIG. 4 illustrates an example computer system in which embodiments can be implemented.

The features of various embodiments will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

While embodiments described herein with are illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

The embodiments described herein are referred in the specification as “one embodiment,” “an embodiment,” “an example embodiment,” etc. These references indicate that the embodiment(s) described can include a particular feature, structure, or characteristic, but every embodiment does not necessarily include every described feature, structure, or characteristic. Further, when a particular feature, structure, or characteristic is described in connection with an embodiment, it is understood that it is within the knowledge of one skilled in the art to affect such feature, structure, or characteristic in connection with other embodiments whether or not explicitly described.

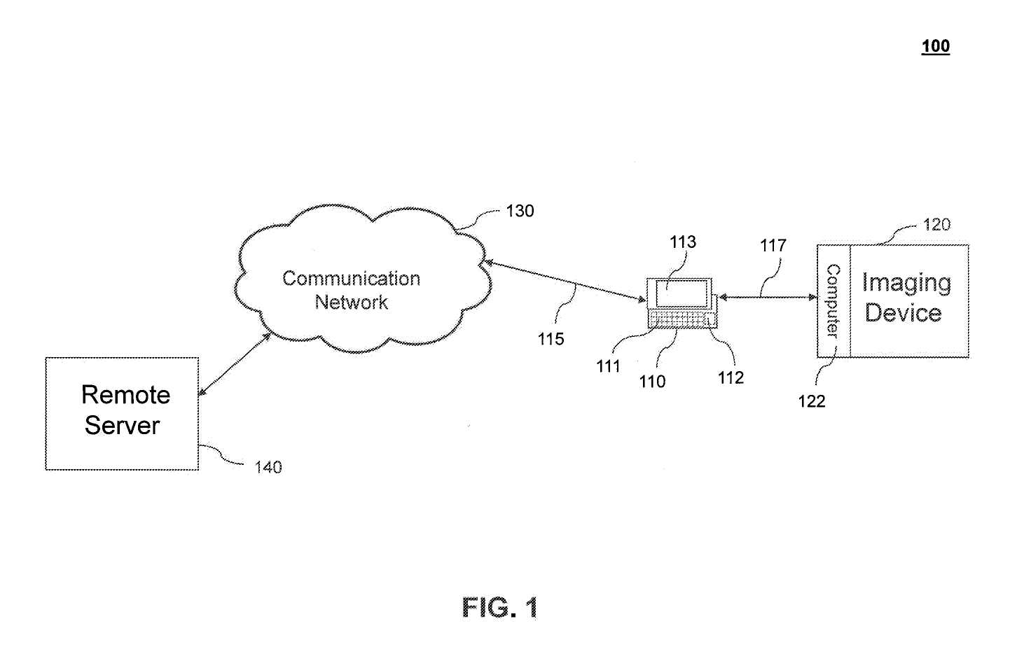

FIG. 1 illustrates a system 100 having a portable image system with a mobile communication device as an input and output mechanism with an imaging device, according to an embodiment. In the example shown in FIG. 1, system 100 includes a mobile communication device 110, an imaging device 120, a communication network 130, and a remote server 140. Mobile communication device 110 communicates with imaging device 120 by sending and receiving information over communication path 117. Mobile communication device 110 further includes the ability to communicate over communication network 130 utilizing communication path 115. Mobile communication device 110 can also include a user interface, such as a keypad 111, a cursor control 112, and/or a presentation screen 113. Imaging device 120 further includes a computer 122.

In an embodiment, imaging device 120 is a portable system, and in another embodiment is capable of self propulsion. Such a portable imaging system can be used to capture panoramic images inside a building, or enclosed space. Given the physical constraints of buildings it is therefore highly desirable for a portable imaging system, such as imaging device 120, to be as lightweight and power efficient as possible. Efficiencies of space and power consumption can be accomplished by including in imaging device 120, for example, a miniature personal computer that can also be referred to as an image device controller, where there is no display screen or input and output device that consumes power and occupies space.

In an embodiment, input and output control and presentation of information to a user is accomplished through the use of mobile communication device 110. The use of mobile communication device 110 provides a user interface between a user and imaging device 120 that allows imaging device 120 to be configured without an onboard display screen and input and output devices as previously mentioned. In addition, such a configuration allows a user to control imaging device 120 through the use of mobile communication device 110 without having to be physically located next to imaging device 120. In an embodiment, mobile communication device 110 can control multiple imaging devices in a given area and does not have to be physically present next to any particular imaging device. In such an approach mobile communication device 110 can not only control multiple imaging devices, but can also gather data=such as captured images and status information, from each imaging device.

In an embodiment, when imaging device 120 is inside a building or structure, network connectivity may not be possible. In fact, it is possible that imaging device 120 does not have the ability to communicate with mobile communication device 110, for instance due to walls in a building that preclude wireless communication. In such a situation imaging device 120 can locally store information, for example captured images, until communications can be restored. In an embodiment, when communication between imaging device 120 and mobile communication device 110 is restored, then information that is stored on imaging device 120 can be transferred to mobile communication device 110. If mobile communication device 110 has access to communication network 130 and remote server 140, information can be transferred to and from remote server 140. However, in the situation that either communication network 130 and/or remote server 140 are not accessible, then mobile communication device 110 can hold such information until communications are available. The similar situation may occur when mobile communication device 110 has communication connectivity to remote server 140 but may not have communication connectivity to imaging device 120, in which case mobile communication device will hold such information until a communication path with imaging device 120 becomes available.

In an embodiment, imaging device 120 is configured to capture a plurality of images of one or more portions of a panoramic image. In an embodiment, each of the plurality of images of the one or more portions of the panoramic image can be taken with a different setting in imaging device 120. For instance, a different exposure setting for imaging device 120 can correspond to each of the plurality of images (e.g., exposure bracketing). The plurality of images, each with a different setting in imaging device 120 (e.g., exposure setting), can then be merged into a resulting panoramic image. The operator of imaging device 120 can manually or electronically control the imaging device 120 to capture one or more portions of the panoramic image, according to an embodiment

In another embodiment, imaging device 120 can be used as a point-of-interest (POI) imaging device. For instance, imaging device 120 can be used to capture an image of a particular POI in the scene (e.g., artwork hanging on a wall, sign on a door, etc.). In an embodiment, imaging device 120 can include a stereoscopic imaging device.

In reference to FIG. 1, imaging device 120 can also be electronically controlled by a user utilizing computer 122, in an embodiment. Such control can include, for example, adjustment of photographic settings such as focus, aperture, shutter speed, zoom, rotational positioning, height positioning, shutter control, and other similar type settings. In addition, control can also include positioning of imaging device 120, e.g., placement within a building or room. Further description of embodiments of imaging device 120 can be found in co-pending application Ser. No. 12/971,887, attorney docket number 2525.2800000, which is incorporated herein by reference in its entirety.

in an embodiment, computer 122 includes a miniature personal computer without a keyboard or screen, e.g., a FIT-PC2 from CompuLab Ltd. of Haifa, Israel. Computer 122 is connected to associated controllers, not shown, within imaging device 120 to electronically control the various functions of imaging device 120. In an embodiment, such a computer is used due to its small size and power consumption, e.g., approximately 8 watts of power consumption and weighing approximately 13 ounces, to allow imaging device 120 to operate from battery power, not shown, for extended periods of time. In addition, such small power consumption allows for operation of imaging device 120 utilizing a relatively smaller battery thereby contributing to a reduction of the overall weight and size of imaging device 120.

In an embodiment, computer 122 includes a storage device, not shown, with the ability to store information. Such information can include images captured by imaging device 120, status information regarding imaging device 120, or any other related information. The storage device may contain information that is to be uploaded to mobile communication device 110 as previously described, or it may contain information downloaded from mobile communication device 110 as previously described. The storage device may also store images taken by imaging device 120.

In an embodiment, mobile communication device 110 communicates with imaging device 120 over communication path 117. Communication path 117 carries signals and may be implemented using wire or cable, fiber optics, a phone line, a cellular phone link, an RF link, or other communication channels. Furthermore, a wireless link utilizing communication path 117 can utilize a short-range or long-range wireless protocol. In an embodiment, computer 122 of imaging device 120 includes a wired and/or wireless communication port that controls communication between mobile communication device 110 and imaging device 120.

Mobile communication device 110 can also include multiple user interfaces including, but not limited to, a keyboard, a touch screen, a pointing device, a scanner, a speaker, and/or a microphone.

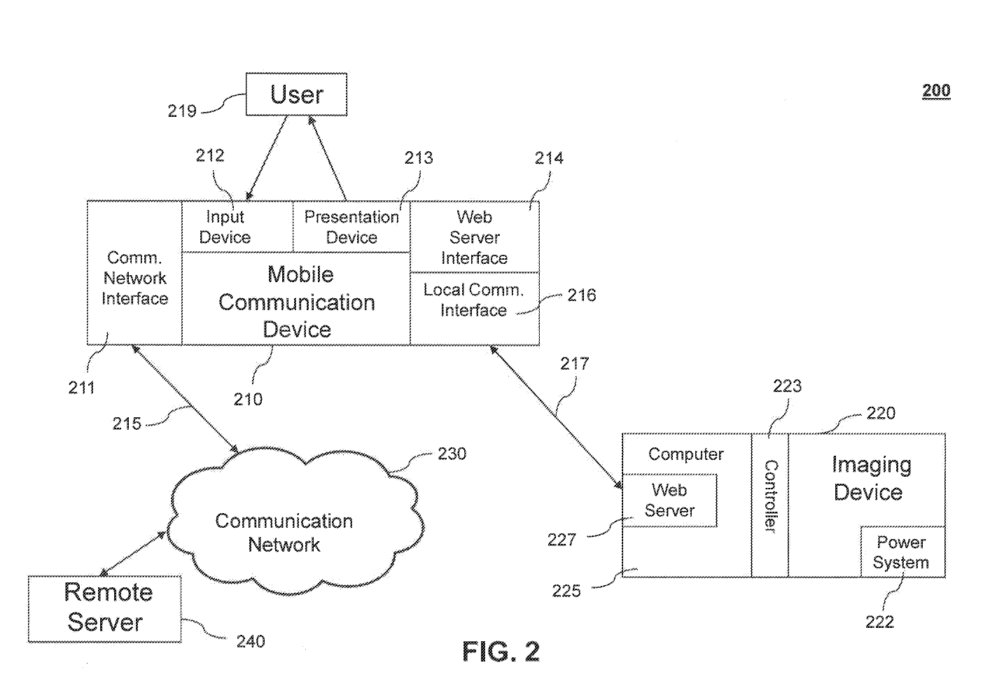

Mobile communication device 110, in an embodiment, includes keypad 111 and cursor control 112 to allow a user to input commands to mobile communication device 110 that are processed and routed to imaging device 120 as will be explained in more detail in FIG. 2. Mobile communication device 110 also may include a presentation device 113 to present information to the user. A combination of keypad 111, cursor control 112, and presentation device 113 on mobile communication device 110 allow the user to issue commands to imaging device 120 and to view information, e.g., responses, status, data, to and from imaging device 120, according to an embodiment.

Mobile communication device 110 communicates with communication network 130 utilizing communication path 115. In an embodiment, mobile communication device 110, through communication path 115 and communication network 130, can access remote server 140. Such access provides a linking mechanism between imaging device 120 and remote server 140. Such a linking mechanism allows for storage of information on remote server 140 that has been collected by imaging device 120 as well as the ability for remote server 140 to issue command and control signals through communication network 130 and mobile communication device 110 to imaging device 120 in order to remotely control, in a full or partial manner, the actions of imaging device 120.

In an embodiment, mobile communication device 110 allows a user to input commands to mobile communication device 110 that are processed and routed to a remote server 140. A combination of keypad 111, cursor control 112, and presentation device 113 on mobile communication device 110 allow the user to issue commands to remote server 140 and to view information, e.g., responses, status, data, to and from remote server 140, according to an embodiment.

FIG. 2 illustrates a detailed view of system 200 having a portable imaging system with a mobile communication device as an input and output mechanism to an imaging device, according to an embodiment. In the example shown in FIG. 2, system 200 includes mobile communication device 210, imaging device 220, communication network 230, and remote server 240. Mobile communication device 210 includes an input device 212 and presentation device 213, directed to accept information from and present information to a user 219. Mobile communication device 210 also includes two communication interfaces, a communication network interface 211, and a local communication network interface 216. Mobile communication device 210 also includes a web server interface 214. Mobile communication device 210 communicates with imaging device 220 over communication path 217 and can also communicate with multiple other systems and devices connected to communication network 230 over communication path 215.

In an embodiment, imaging device 220 includes a power system 222, a controller 223, a computer 225, and a web server 227.

Power system 223 is configured to provide a regulated voltage to imaging device 220 in an embodiment. In an embodiment in which imaging device 220 can be attached to an external power source, e.g., a building power outlet, generator, or battery source, power system 222 is configured to convert the voltage level of the external power supply to a desirable operating voltage(s) for imaging device 220. Devices and methods used to regulate voltages, such as AC-DC and DC-DC converters, are known to a person skilled in the relevant art.

In an embodiment in which imaging device 220 does not have access to an external power supply, power system 222 can be a rechargeable power supply that provides power at the desirable operating voltage(s) for imaging device 220. In an embodiment, the rechargeable power supply of power system 222 can be replenished by another power supply source such as, for example and without limitation, an AC power supply (e.g., a building power outlet). Based on the description herein, a person skilled in the relevant art will recognize that other power systems can be used for power system 222. These other power systems are within the scope and spirit of the embodiments described herein.

In an embodiment, controller 223 has the ability to control the functionality of imaging device 220, including, for example, image capture settings as previously described in system 100 of FIG. 1. In addition, controller 223 may have the ability to control movement and positioning of imaging device 220. In an embodiment, imaging device 220 can include locomotion capabilities, e.g., wheels or tracks, that allow image device 220 to be positioned under image device 220's own power.

In an embodiment, imaging device 220 includes a computer 225. Computer 225 communicates with controller 223 and can issue control commands to controller 223 in order to control the functionality of imaging device 220. In a like manner, computer 225 can also receive information from controller 223. Such information can include real time health monitoring information of imaging device 220, as well as information such as captured images, storage status, battery status, and any other information available from imaging device 220.

According to a further embodiment, computer 223 may include a web server 227 or may be coupled to communicate with a web server at the same or a different location. In an embodiment, a web server is a software component that responds to an HTTP request with an HTTP response. As illustrative examples, web server 227 may be, without limitation, an Apache HTTP Server, Apache Tomcat, MICROSOFT Internet Information Server, JBOSS Application Server, WEBLOGIC Application Server, or SUN JAVA System Web Server. The web server may contain web applications which generate content in response to an HTTP request. The web server may package the generated content and serve the content to a client in the form of an HTTP response. Such content may include HTML, extensible markup language (XML), documents, videos, images, audio, multimedia features, or any combination thereof. This example is strictly illustrative and does not limit the present invention.

In an embodiment, web server 227 includes a web application to forward control information to controller 223 and also receive information from controller 223 as previously discussed.

Web server 227 is configured to communicate over communication path 217 to mobile communication device 210, according to an embodiment. Communication path 217 carries signals and may be implemented using wire or cable, fiber optics, a phone line, a cellular phone link, an RF link or other communication channels. Furthermore, a wireless link utilizing communication path 217 can utilize a short-range or long-range wireless protocol.

Broadly speaking, mobile communication device 210 provides a mechanism for receiving instructions from a user that are communicated to imaging device 220 in an embodiment. In a similar manner, mobile communication device 210 provides a mechanism for presenting information to a user that has either originated from imaging device 220 or from remote system 240 over communication network 230. By utilizing mobile communication device 210 as an input and output device with imaging device 220, imaging device 220 does not need to be configured with a dedicated laptop computer having a network connection that requires substantially more energy than the miniature personal computer previously discussed. In addition, the use of mobile communication device 210 as the input and output device for imaging device 220 also allows for remote control of imaging device 220. In a similar manner, mobile communication device 210 provides a mechanism for providing network access to remote server 240, according to an embodiment. Such access allows information, such as images captured by imaging device 220 and status information, to be communicated to and stored on remote server 240.

Local communication interface 216, in mobile communication device 210, provides a wired or wireless connection over communication path 217 to imaging device 220. Communication path 217 may be implemented using wire or cable, fiber optics, a phone line, a cellular phone link, an RF link or other communication channels and can utilize a short-range or long-range wireless protocol.

In an embodiment, mobile communication device includes web server interface 214 that is configured to communicate with web server 227 in imaging device 220. Input device 212 and presentation device 213, in conjunction with web server interface 214, provide user 219 with an interface for viewing image content, requesting information, and inputting commands to imaging device 220, according to an embodiment. Web server interface 214 may provide navigation tools familiar to users of applications and familiar to those of ordinary skill in the art. In one exemplary embodiment, web server interface 214 may be configured to provide a user interface and navigation tools in a browser. For example, a browser may be a web browser or other type of browser for browsing content. The browser can send a request over local communication interface 216 to web server 227 and receive a response from web server 227. As an example, not to limit the present invention, the request may be a hypertext transfer protocol (HTTP) request. The HTTP request may contain parameters entered by a user using a user interface. The response may be an HTTP response. An HTTP response may contain web content, such as a hypertext markup language (HTML), images, video, or multimedia content. In some embodiments, web server interface 214 may use a combination of markup and scripting elements, such as, for example, HTML and/or JavaScript. A user interface can also be executed as a script within a browser, as a plug-in within a browser, or as a program which executes within a browser plug-in, such as the ADOBE (MACROMEDIA) Flash plug-in. Web server interface 214 may also operate a user interface as a standalone application in other embodiments.

In an embodiment, mobile communication device 220 includes web server interface 214 that is configured to communicate with remote server 240. As described above, web server interface 214 may be configured to provide a user interface and navigation tools in a browser. The browser can send a request over communication network interface 211 to communication path 215, through communication network 230, to access and receive a response from remote server 240.

In an embodiment, mobile communication device 210 provides a link between remote server 240 and imaging device 220. In this embodiment remote server 240 can issue commands to imaging device 220 with the ability to control the functionality of imaging device 220. In a similar manner, remote server can also receive information from imaging device 220 through mobile communication device 210. Such an arrangement allows remote server 240 to provide real time maintenance of imaging device 220 that can include real time status check of imaging device 220, virtual access for real time debugging, and the ability to upgrade, alter, and replace software components on either, or both, mobile communication device 210 and imaging device 220.

Either remote server 240 or mobile communication device 210 can initiate communication with the other. In the same manner, imaging device 220 can also initiate communications with either mobile communication device 210 or remote server 240. Such communications provide a link between any remote server 240, mobile communication device 210, and imaging device 220.

### Method

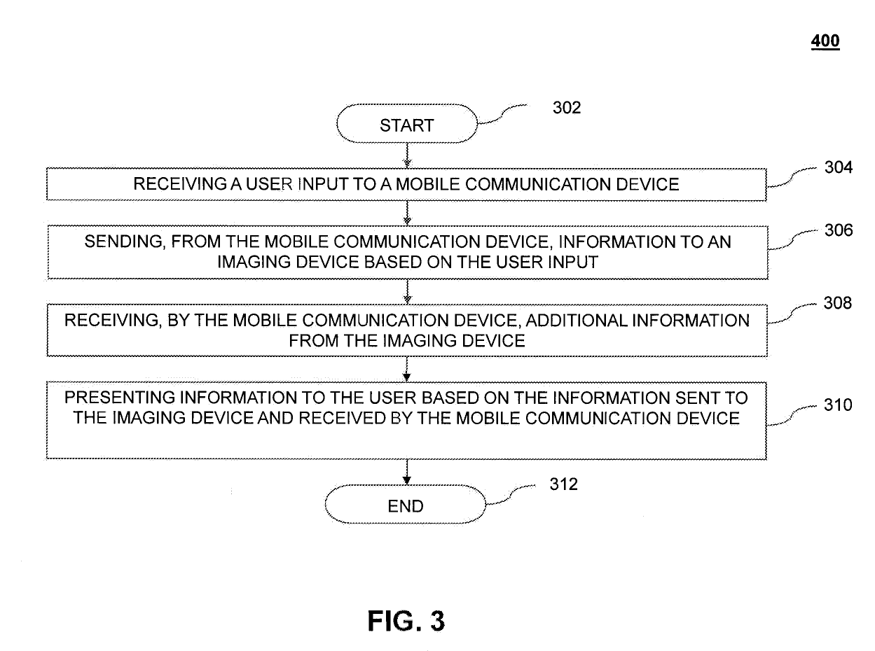

FIG. 3 illustrates a method 300 for control of an imaging device using a mobile communication device as an input and output mechanism, according to an embodiment. In the example shown in FIG. 3, the method starts with step 302. Step 304 continues by receiving a user input to a mobile communication device. For example, FIG. 2 illustrates mobile communication device 210 configured with input device 212 and presentation device 213 to receive user input and present information to the user. Step 306 continues by sending, from the mobile communication device, information to an imaging device based on the user input. For example, FIG. 2 illustrates the ability to send information to imaging device 220 through a local communication interface 216. Step 308 continues by receiving, by the mobile communication device, additional information from the imaging device. For example, FIG. 2 illustrates the ability to send and receive information with imaging device 220 through communication path 217. Additional information can include, for example, data from imaging system 220 for debugging purposes, captured image information, status information, and the like. Step 310 continues by presenting the additional information to the user based on the information sent to the imaging device and received by the mobile communication device. For example, FIG. 2 illustrates the ability to present information to a user utilizing presentation device 213. Step 312 concludes the method.

### Example Computer System Implementation

Aspects of the present invention shown in FIGS. 1-3, or any part(s) or function(s) thereof, may be implemented using hardware, software modules, firmware, tangible computer readable media having instructions stored thereon, or a combination thereof and may be implemented in one or more computer systems or other processing systems.

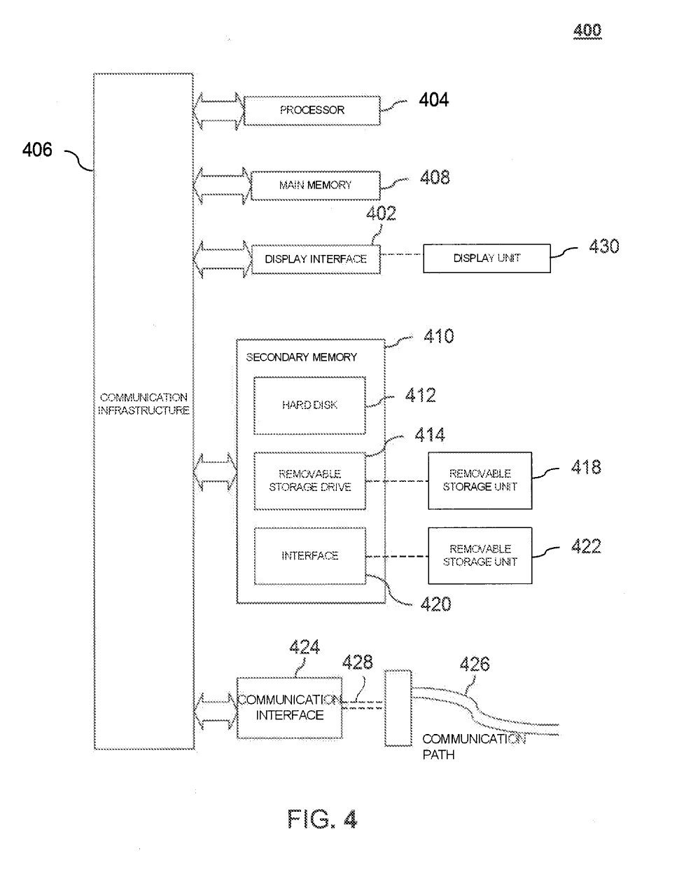

FIG. 4 illustrates an example computer system 400 in which embodiments, or portions thereof, may by implemented as computer-readable code. For example, portions of system 200, e.g., remote server 240, mobile communication device 210, computer 225, and controller 223, may be implemented in portions of computer system 400 using hardware, software, firmware, tangible computer readable media having instructions stored thereon, or a. combination thereof and may be implemented in one or more computer systems or other processing systems. Hardware, software, or any combination of such may embody any of the modules and components in FIGS. 1-3.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, and mainframe computers, computer linked or clustered with distributed functions, as well as pervasive or miniature computers that may be embedded into virtually any device.

For instance, at least one processor device and a memory may be used to implement the above described embodiments. A processor device may be a single processor, a plurality of processors, or combinations thereof. Processor devices may have one or more processor “cores.”

Various embodiments of the invention are described in terms of this example computer system 400. After reading this description, it will become apparent to a person skilled in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 404 may be a special purpose or a general purpose processor device. As will be appreciated by persons skilled in the relevant art, processor device 404 may also be a single processor in a multi-core/multiprocessor system, such system operating alone, or in a cluster of computing devices operating in a cluster or server farm. Processor device 404 is connected to a communication infrastructure 406, for example, a bus, message queue, network, or multi-core message-passing scheme.

Computer system 400 also includes a main memory 408, for example, random access memory (RAM), and may also include a secondary memory 410. Secondary memory 410 may include, for example, a hard disk drive 412, removable storage drive 414. Removable storage drive 414 may include a floppy disk drive, a magnetic tape drive, an optical disk drive, a flash memory, or the like. The removable storage drive 414 reads from and/or writes to a removable storage unit 418 in a well known manner. Removable storage unit 418 may include a floppy disk, magnetic tape, optical disk, etc. which is read by and written to by removable storage drive 414. As will be appreciated by persons skilled in the relevant art, removable storage unit 418 includes a computer usable storage medium having stored therein computer software and/or data.

Computer system 400 (optionally) includes a display interface 402 (which can include input and output devices such as keyboards, mice, etc.) that forwards graphics, text, and other data from communication infrastructure 406 (or from a frame buffer not shown) for display on display unit 430.

In alternative implementations, secondary memory 410 may include other similar means for allowing computer programs or other instructions to be loaded into computer system 400. Such means may include, for example, a removable storage unit 422 and an interface 420. Examples of such means may include a program cartridge and cartridge interface (such as that found in video game devices), a removable memory chip (such as an EPROM, or PROM) and associated socket, and other removable storage units 422 and interfaces 420 which allow software and data to be transferred from the removable storage unit 422 to computer system 400.

Computer system 400 may also include a communication interface 424. Communication interface 424 allows software and data to be transferred between computer system 400 and external devices. Communication interface 424 may include a modem, a network interface (such as an Ethernet card), a communication port, a PCMCIA slot and card, or the like. Software and data transferred via communication interface 424 may be in the form of signals, which may be electronic, electromagnetic, optical, or other signals capable of being received by communication interface 424. These signals may be provided to communication interface 424 via a communication path 426. Communication path 426 carries signals and may be implemented using wire or cable, fiber optics, a phone line, a cellular phone link, an RF link or other communication channels.

In this document, the terms “computer program medium” and “computer usable medium” are used to generally refer to media such as removable storage unit 418, removable storage unit 422, and a hard disk installed in hard disk drive 412. Computer program medium and computer usable medium may also refer to memories, such as main memory 408 and secondary memory 410, which may be memory semiconductors (e.g. DRAMs, etc.).

Computer programs (also called computer control logic) are stored in main memory 408 and/or secondary memory 410. Computer programs may also be received via communication interface 424. Such computer programs, when executed, enable computer system 400 to implement the present invention as discussed herein. In particular, the computer programs, when executed, enable processor device 404 to implement the processes of the present invention, such as the stages in the method illustrated by flowchart 300 of FIG. 3 discussed above. Accordingly, such computer programs represent controllers of the computer system 400. Where the invention is implemented using software, the software may be stored in a computer program product and loaded into computer system 400 using removable storage drive 414, interface 420, and hard disk drive 412, or communication interface 424.

Embodiments of the invention also may be directed to computer program products comprising software stored on any computer useable medium. Such software, when executed in one or more data processing device, causes a data processing device(s) to operate as described herein. Embodiments of the invention employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

### Conclusion

Embodiments described herein provide methods and apparatus for the automatic cropping of images. The summary and abstract sections may set forth one or more but not all exemplary embodiments as contemplated by the inventors, and thus, are not intended to limit the present invention and the claims in any way.

The embodiments herein have been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

The foregoing description of the specific embodiments will so fully reveal the general nature of the invention that others may, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the claims and their equivalents.

What is claimed is:

1. An imaging system, comprising:
an imaging device;
an image device controller coupled to the imaging device;
a data storage device coupled to the image device controller and configured to store information from the imaging device; and
a mobile communication device removably coupled to the imaging device controller, the mobile communication device configured to provide an interface to the imaging device, and comprising:
an input device configured to accept input from a user;
a presentation device configured to convey information to the user;
a local communication interface configured to send and receive information between the mobile communication device and the imaging device; and
a communication network interface configured to access a communication network and transfer data between the communication network and the imaging device.

2. The system of claim 1, wherein the sending and receiving of information between the mobile communication device and the imaging system utilizes a wired connection.

3. The system of claim 1, wherein the sending and receiving of information between the mobile communication device and the imaging system utilizes a wireless connection.

4. The system of claim 3, wherein the wireless connection utilizes a short-range wireless protocol.

5. The system of claim 1, wherein the input device comprises at least one of:
a touch screen;
a keyboard;
a pointing device;
a microphone; and
a scanner.

6. The system of claim 1, wherein the imaging system further comprises a web server configured to generate a plurality of web pages.

7. The system of claim 6, wherein the mobile communication device further comprises a web server interface to interact with the plurality of web pages.

8. The system of claim 1, further comprising a power unit configured to provide power to the imaging device.

9. The system of claim 1, wherein the imaging device is further configured to capture a panoramic image.

10. The system of claim 1, wherein the mobile communication device is further configured to transfer data between the communication network and the imaging device.

11. A method, comprising:
receiving a user input directed to a mobile communication device;
removably coupling the mobile communication device to an image device controller;
sending information from the mobile communication device to the image device controller to initiate a function on the imaging device based on the user input;
receiving information from the imaging system at the mobile communication device;
presenting information from the mobile communication device to the user based on the information sent and received between the mobile communication device and the imaging system;
accessing a communication network using the mobile communication device; and transferring information between the imaging system and the communication network using the mobile communication device.

12. The method of claim 11, wherein the sending and receiving of information between the mobile communication device and the imaging system utilizes a wired connection.

13. The method of claim 11, wherein the sending and receiving of information between the mobile communication device and the imaging system utilizes a wireless connection.

14. The system of claim 13, wherein the wireless connection utilizes a short-range wireless protocol.

15. The method of claim 11, wherein the receiving a user input and the presenting information to the user comprises displaying information via a display on the mobile communication device related to the transferring and receiving of information between the mobile communication device and the imaging system.

16. The method of claim 11, further comprising using a web server to generate a plurality of web pages.

17. The method of claim 16, further comprising accessing a web server interface from the mobile communication device to interact with the plurality of web pages.

18. The method of claim 11, further comprising capturing a panoramic image.
